(19) United States
(12) Patent Application Publication
(10) Pub. No.: US 2024/0182767 A1
(43) Pub. Date: Jun. 6, 2024

(54) CURABLE PERFLUOROPOLYETHER ADHESIVE COMPOSITION AND ADHESIVE AND ADHESIVE TAPE USING CURED PRODUCT THEREOF

(71) Applicant: SHIN-ETSU CHEMICAL CO., LTD., Tokyo (JP)

(72) Inventor: Hiroyuki YASUDA, Tomioka-shi (JP)

(73) Assignee: SHIN-ETSU CHEMICAL CO., LTD., Tokyo (JP)

(21) Appl. No.: 18/281,610

(22) PCT Filed: Mar. 2, 2022
(86) PCT No.: PCT/JP2022/008724

§ 371 Date: Sep. 12, 2023

(30) Foreign Application Priority Data
Mar. 15, 2021 (JP) 2021-041200

(51) Int. Cl. C09J 183/12; C08G 77/00; C08G 77/46; C08K 3/36; C09J 7/38; C09J 11/04

(52) U.S. Cl. CPC C09J 183/12; C08G 77/46; C08K 3/36; C09J 7/38; C09J 11/04; C08G 77/80; C09J 2301/414; C09J 2483/00

(57) ABSTRACT

A curable perfluoropolyether adhesive composition including: (A) a linear perfluoropolyether compound having at least two alkenyl groups per molecule and having a perfluoropolyether structure containing a repeating unit represented by —CₐF₂ₐO— in a main chain, wherein “a” represents an integer of 1 to 6: 100 parts by mass; (B) a fluorine-containing organohydrogenpolysiloxane having at least two silicon atom-bonded hydrogen atoms per molecule: an effective curing amount; and (C) a hydrosilylation-reaction catalyst: a catalytic amount. The curable perfluoropolyether adhesive composition does not contain any organic solvent in the composition. This provides a curable perfluoropolyether adhesive composition that produces a cured product with excellent heat resistance, weather resistance, water repellency, oil repellency, chemical resistance, solvent resistance, etc., and particularly free of voids that may otherwise occur on the coating film surface during heating processes, as well as an adhesive and an adhesive tape including the cured product.

### TECHNICAL FIELD

The present invention relates to a curable perfluoropolyether adhesive composition (hereinafter also referred to as a perfluoropolyether adhesive composition) that forms an adhesive (perfluoropolyether rubber cured product or perfluoropolyether gel cured product) having excellent heat resistance, oil resistance, chemical resistance, solvent resistance, low-temperature properties, moisture resistance, low gas permeability, etc., and particularly providing a smooth coating film without any voids on the cured film surface, as well as an adhesive and an adhesive tape including a cured product of the composition.

### BACKGROUND ART

Some publications have proposed obtaining a cured product with well-balanced properties of heat resistance, chemical resistance, solvent resistance, water repellency, oil repellency, weather resistance, etc. from a composition that contains: a linear perfluoropolyether compound having at least two alkenyl groups per molecule and having a perfluoropolyether structure in a main chain; an organosilicon compound, such as fluorine-containing organohydrogenpolysiloxane having two or more H—SiOSiO structures per molecule; and a hydrosilylation-reaction catalyst (Patent Documents 1 and 2).

Meanwhile, adhesives are used in various applications, including, among others, labels attached to products and adhesive tapes. More recently, advances in electronic terminal-related technologies have allowed the use of adhesives to find wider applications, including adhesive films for protecting displays and protective films for use during product manufacturing processes. Further, besides the surface protection, adhesives are now used in optical components by taking advantage of the transparency of the material, and applications for use inside products are being developed, as typified by optical clear adhesive tapes (OCA tapes).

Adhesives are generally classified into acrylic, rubber, and silicone types, each having advantages and disadvantages. Silicone adhesives are less economical than acrylic and rubber adhesives, but are superior to these other two types of adhesives in properties such as heat resistance, cold resistance, weather resistance, chemical resistance and electric insulation.

Mobile phones and other terminals have recently been widespread. Most adhesive films for protecting the displays of these terminals are based on silicone adhesives. Since silicone, by nature, has good wettability to adherends, no air bubbles will be entrained during bonding of such an adhesive film and also the adhesive film will not shift or peel off by itself. Additionally, the adhesive film can be rebonded as it has good reworkability (Patent Document 3). A similar context applies to protective films for use during product manufacturing processes, which further require heat resistance and other properties, so that a large quantity of adhesive films based on silicone adhesives is used.

Among mobile phones, those terminals with more sophisticated functions than conventional ones, called smartphones, are spreading rapidly. Many smartphones can be operated by touching a display called a touch panel, instead of conventional buttons. Similar terminals include tablet terminals, which are portable computers equipped with touch panels. As the area of displays increases with the spread of these terminals, demand for adhesive films for screen protection is increasing.

Although such current silicone adhesives have sufficient performance for most applications, there has been a strong need for the development of an adhesive composition with excellent chemical resistance and solvent resistance for applications such as barcode labels for use around vehicle engines and in clinical and pathological testing processes, where additional chemical resistance and solvent resistance are required.

In this context, a curable perfluoropolyether adhesive composition has been proposed (Patent Document 4). The composition is shown to produce a cured product that is excellent not only in heat resistance, weather resistance, water repellency, oil repellency, etc., but also in chemical resistance and solvent resistance. However, the illustrated composition contains a trace amount of an organic solvent such as ethanol and toluene. Therefore, in some cases, when the coating film is heated and cured, the organic solvent is evaporated within the film, generates voids, and impairs the flatness of the coating film surface due to the low gas permeability of fluorine materials.

### CITATION LIST

### Patent Literature

Patent Document 1: JP 2990646 B2

Patent Document 2: JP 2000-248166 A

Patent Document 3: JP H07-197008 A

Patent Document 4: JP 2019-038904 A

### SUMMARY OF INVENTION

### Technical Problem

The present invention has been made under the above circumstances. An object of the present invention is to provide a curable perfluoropolyether adhesive composition that produces a cured product with excellent heat resistance, weather resistance, water repellency, oil repellency, chemical resistance, solvent resistance, etc., and particularly free of voids that may otherwise occur on the coating film surface during heating processes, as well as an adhesive and an adhesive tape including the cured product.

### Solution to Problem

To achieve the above object, the first aspect of the present invention provides a curable perfluoropolyether adhesive composition comprising:
(A) a linear perfluoropolyether compound having at least two alkenyl groups per molecule and having a perfluoropolyether structure containing a repeating unit represented by —CₐF₂ₐO— in a main chain, wherein “a” represents an integer of 1 to 6: 100 parts by mass;
(B) a fluorine-containing organohydrogenpolysiloxane having at least two silicon atom-bonded hydrogen atoms per molecule: an effective curing amount; and
(C) a hydrosilylation-reaction catalyst: a catalytic amount,
wherein the curable perfluoropolyether adhesive composition does not contain any organic solvent in the composition.

Such a curable perfluoropolyether adhesive composition containing the components (A) to (C) and free of organic solvents as in the first aspect of the present invention can produce a cured product (adhesive) having excellent heat resistance, weather resistance, water repellency, oil repellency, oil resistance, low-temperature properties, moisture resistance, low gas permeability, etc., and in particular providing a smooth coating film without any voids on the cured film surface. Also, the inventive curable perfluoropolyether adhesive composition containing the components (A) to (C) and free of organic solvents as described above can produce a rubber cured product (perfluoropolyether rubber cured product).

The first aspect of the present invention provides the curable perfluoropolyether adhesive composition further comprising (E) an organic solvent-free addition reaction regulator in an amount of 0.01 to 5 parts by mass relative to 100 parts by mass of the component (A).

Such an inventive curable perfluoropolyether adhesive composition containing the organic solvent-free component (E) is improved in workability as it does not thicken or gel during its preparation or application onto substrates, and can produce a cured product (adhesive) having excellent heat resistance, weather resistance, water repellency, oil repellency, oil resistance, low-temperature properties, moisture resistance, low gas permeability, etc., and in particular providing a smooth coating film without any voids on the cured film surface.

The first aspect of the present invention provides the curable perfluoropolyether adhesive composition further comprising (F) a hydrophobic silica powder in an amount of 0.5 to 20 parts by mass relative to 100 parts by mass of the component (A). The hydrophobic silica powder (F) is essentially organic solvent-free.

When the adhesive composition contains such a hydrophobic silica powder, the curable perfluoropolyether adhesive composition can have excellent scratch resistance.

The second aspect of the present invention provides a curable perfluoropolyether adhesive composition comprising:
(A) a linear perfluoropolyether compound having at least two alkenyl groups per molecule and having a perfluoropolyether structure containing a repeating unit represented by —CₐF₂ₐO— in a main chain, wherein “a” represents an integer of 1 to 6: 100 to 40 parts by mass;
(D) a polyfluoromonoalkenyl compound having one alkenyl group per molecule and having a perfluoropolyether structure in a main chain: 0 to 60 parts by mass, wherein the components (A) and (D) are in an amount of 100 parts by mass in total;
(B) a fluorine-containing organohydrogenpolysiloxane having at least two silicon atom-bonded hydrogen atoms per molecule: an effective curing amount; and
(C) a hydrosilylation-reaction catalyst: a catalytic amount,
wherein the curable perfluoropolyether adhesive composition does not contain any organic solvent in the composition.

The second aspect of the present invention provides the curable perfluoropolyether adhesive composition containing the component (D) in an amount of 0.1 to 60 parts by mass relative to 99.9 to 40 parts by mass of the component (A), wherein the components (A) and (D) are in an amount of 100 parts by mass in total.

Such a curable perfluoropolyether adhesive composition containing the components (A) to (D) and free of organic solvents as in the second aspect of the present invention can produce a cured product (adhesive) having excellent heat resistance, weather resistance, water repellency, oil repellency, oil resistance, low-temperature properties, moisture resistance, low gas permeability, etc., and in particular providing a smooth coating film without any voids on the cured film surface. Also, the inventive curable perfluoropolyether adhesive composition containing the components (A) to (D) and free of organic solvents as described above can produce a rubber cured product or gel cured product (perfluoropolyether rubber cured product or gel cured product).

As used herein, the term “perfluoropolyether gel cured product” (hereinafter also referred to as “perfluoropolyether gel”) refers to a perfluoropolyether-based cured product having a low crosslinking density and having a penetration (also called a cone penetration) of 10 to 100, the penetration specified in JIS K6249 and measured by a cone penetration testing method in accordance with JIS K2220 (¼ cone). This is equivalent to a measurement value (rubber hardness value) of 0 in rubber hardness measurement in accordance with JIS K6301, which corresponds one that is so low in hardness (i.e., soft) and low in elasticity (low stress) that it does not exhibit an effective rubber hardness value. In this regard, it is distinct from so-called perfluoropolyether rubber cured products (elastic rubbers).

The cured coating film of the perfluoropolyether gel cured product with a softness of 10 to 100 in penetration as specified in JIS K6249 and measured in accordance with JIS K2220 (¼ cone) described above generally corresponds to soft coating films of 6B or softer in a pencil hardness test (scratch resistance test based on 45° scratching with a pencil lead in accordance with JIS K5600-5-4), whereas a cured coating film of perfluoropolyether rubber cured products (elastic rubbers) generally exhibits a scratch resistance of 5B or harder in the same test.

In the second aspect of the present invention, the component (D) is preferably a polyfluoromonoalkenyl compound represented by the following general formula (2):

Rf¹—(X′)ₚ—CH═CH₂ (2)
wherein X′ represents —CH₂—, —OCH₂—, —CH₂OCH₂—, or —CO—NR²—Y′—, wherein Y′ represents —CH₂— or a group represented by the following structural formula (Z′) (i.e., a dimethylphenylsilylene group in an ortho-, meta-, or para-position):

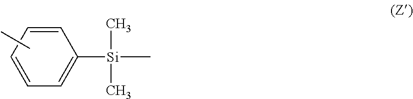

and R² represents a hydrogen atom, a methyl group, a phenyl group, or an allyl group,
wherein “p” represents 0 or 1, and Rf¹ represents a perfluoropolyether structure represented by a general formula: F—[CF(CF₃)CF₂O]_{w}—CF(CF₃)—, wherein “w” represents an integer of 1 to 500.

When the composition contains such a component (D), the curable perfluoropolyether adhesive composition can produce a cured product (adhesive) with more excellent chemical and solvent resistance.

The second aspect of the present invention provides the curable perfluoropolyether adhesive composition further comprising (E) an organic solvent-free addition reaction regulator in an amount of 0.01 to 5 parts by mass relative to 100 parts by mass of the components (A) and (D) in total.

Such an inventive curable perfluoropolyether adhesive composition containing the organic solvent-free component (E) is improved in workability as it does not thicken or gel during its preparation or application onto substrates, and can produce a cured product (adhesive) having excellent heat resistance, weather resistance, water repellency, oil repellency, oil resistance, low-temperature properties, moisture resistance, low gas permeability, etc., and in particular providing a smooth coating film without any voids on the cured film surface.

The second aspect of the present invention provides the curable perfluoropolyether adhesive composition further comprising (F) a hydrophobic silica powder in an amount of 0.5 to 20 parts by mass relative to 100 parts by mass of the components (A) and (D) in total. The hydrophobic silica powder (F) is essentially organic solvent-free.

When the adhesive composition contains such a hydrophobic silica powder, the curable perfluoropolyether adhesive composition can have excellent scratch resistance.

In the first or second aspect of the present invention, the component (C) does not contain any organic solvent.

Such a component (C) is used to make the composition organic solvent-free.

In the first or second aspect of the present invention, the component (A) is preferably a linear perfluoropolyether compound represented by the following general formula (1):

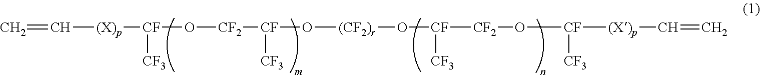

wherein X represents —CH₂—, —CH₂O—, —CH₂OCH₂—, or —Y—NR¹—CO—, wherein Y represents —CH₂— or a group represented by the following structural formula (Z) (i.e., a dimethylphenylsilylene group in an ortho-, meta-, or para-position), and R¹ represents a hydrogen atom, a methyl group, a phenyl group, or an allyl group, wherein X′ represents —CH₂—, —OCH₂—, —CH₂OCH₂—, or —CO—NR²—Y′—, wherein Y′ represents —CH₂— or a group represented by the following structural formula (Z′) (i.e., a dimethylphenylsilylene group in an ortho-, meta-, or para-position), and R² represents a hydrogen atom, a methyl group, a phenyl group, or an allyl group,
wherein “p” independently represents 0 or 1, “r” represents an integer of 2 to 6, “m” and “n” each represent an integer of 0 to 600, and a sum of “m” and “n” is 50 to 600.

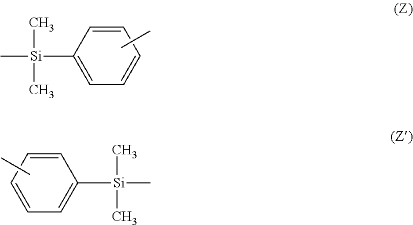

When the composition contains such a component (A), the curable perfluoropolyether adhesive composition can produce a cured product (adhesive) with more excellent chemical and solvent resistance and can also have a high adhesion.

In the first or second aspect of the present invention, the composition is desirably a curable perfluoropolyether adhesive composition that, when cured, forms an adhesive having an adhesion of 0.001 N/25 mm to 10.0 N/25 mm.

As the composition produces a cured product with such an adhesion, the curable perfluoropolyether adhesive composition provides a good adhesion to adherends.

In the first or second aspect of the present invention, a cured product of the curable perfluoropolyether adhesive composition is preferably a non-conductive adhesive having a volume resistivity of 1×10⁹ Ω·cm or more.

The inventive curable perfluoropolyether adhesive composition is suitable for use as a material of such non-conductive adhesives.

The present invention also provides an adhesive comprising a cured product of the above-described curable perfluoropolyether adhesive composition.

As such, the inventive curable perfluoropolyether adhesive composition can be used as an adhesive that produces a perfluoropolyether rubber cured product or a perfluoropolyether gel cured product with excellent adhesion to various substrates.

The present invention also provides an adhesive tape comprising a substrate and a cured product layer of the above-described curable perfluoropolyether adhesive composition laminated thereon.

As such, the cured product layer (the adhesive layer of the perfluoropolyether rubber cured product or the perfluoropolyether gel cured product) of the inventive curable perfluoropolyether adhesive composition can be laminated on a substrate for use as an adhesive tape with a non-conductive adhesive layer.

### Advantageous Effects of Invention

As described above, the inventive curable perfluoropolyether adhesive composition can produce a rubber or gel cured product (adhesive) having excellent heat resistance, weather resistance, oil resistance, low-temperature properties, moisture resistance, low gas permeability, water repellency, oil repellency, chemical resistance, solvent resistance, etc. and particularly providing a smooth coating film without any voids on the cured film surface.

### DESCRIPTION OF EMBODIMENTS

As described above, a need has existed for the development of a curable perfluoropolyether adhesive composition that produces a cured product (adhesive) having excellent heat resistance, weather resistance, water repellency, oil repellency, etc. and particularly providing a smooth coating film without any voids on the cured film surface, as well as an adhesive and an adhesive tape including the cured product.

The present inventors have earnestly studied to achieve the above object and consequently found that the use of particular perfluoropolyether adhesive compositions according to the present invention can yield a composition that produces a rubber or gel cured product (perfluoropolyether rubber cured product or perfluoropolyether gel cured product) having more excellent chemical and solvent resistance than conventional silicone adhesives and particularly produces a cured product (adhesive) providing a smooth coating film without voids on the cured film surface. This finding has led to the present invention.

### First Aspect

That is, the first aspect of the present invention is a curable perfluoropolyether adhesive composition that produces a rubber cured product (perfluoropolyether rubber cured product), comprising:
(A) a linear perfluoropolyether compound having at least two alkenyl groups per molecule and having a perfluoropolyether structure containing a repeating unit represented by —CₐF₂ₐO— in a main chain, wherein “a” represents an integer of 1 to 6: 100 parts by mass;
(B) a fluorine-containing organohydrogenpolysiloxane having at least two silicon atom-bonded hydrogen atoms per molecule: an effective curing amount; and
(C) a hydrosilylation-reaction catalyst: a catalytic amount,
wherein the curable perfluoropolyether adhesive composition does not contain any organic solvent in the composition.

Hereinafter, the first aspect of the present invention will be described in detail, but the present invention is not limited to the following description.

### Component (A)

In the first aspect of the present invention, the component (A) contained in the inventive curable perfluoropolyether adhesive composition functions as a main ingredient (base polymer) of the inventive curable perfluoropolyether adhesive composition, and is a linear perfluoropolyether compound having at least two alkenyl groups per molecule and having a perfluoropolyether structure (perfluorooxyalkylene structure), preferably a divalent perfluorooxyalkylene structure, in a main chain.

Examples of the perfluorooxyalkylene structure include those containing multiple repeating structures of oxyalkylene units shown by —CₐF₂ₐO— (“a” in each unit is independently an integer of 1 to 6) and, for example, shown by the following general formula (3):

(CₐF₂ₐO)_{q} (3)
wherein “q” is an integer of 50 to 600, preferably 50 to 400, more preferably 50 to 200.

Examples of the individual repeating structures —CₐF₂ₐO— (i.e., oxyalkylene units) constituting the perfluorooxyalkylene structure shown by the formula (3) include the following structures. The above perfluoroalkylether structure may be constituted by a single kind of these repeating structures or a combination of two or more kinds thereof.
—CF₂O—
—CF₂CF₂O—
—CF₂CF₂CF₂O—
—CF(CF₃)CF₂O—
—CF₂CF₂CF₂CF₂O—
—CF₂CF₂CF₂CF₂CF₂CF₂O—
—C(CF₃)_{2 O}—

Among these, the following structures are particularly suitable.
—CF₂O—
—CF₂CF₂O—
—CF₂CF₂CF₂O—
—CF(CF₃)CF₂O—

In the present invention, the term “linear” refers to a structure in which the individual repeating units —CₐF₂ₐO— (oxyalkylene units) constituting the perfluoropolyether structure (perfluorooxyalkylene structure) of the main chain are linearly bonded to one another, and each repeating unit (oxyalkylene unit) itself may be a linear oxyalkylene unit or a branched oxyalkylene unit (e.g., —CF(CF₃)CF₂O—, —C(CF₃)₂O—).

The alkenyl groups in the linear perfluoropolyether compound (A) are preferably those having 2 to 8 carbon atoms, particularly 2 to 6 carbon atoms, and having a CH₂═CH— structure at a terminal. Preferred example groups include those having a CH₂═CH— structure at a terminal, such as vinyl, allyl, propenyl, isopropenyl, butenyl, and hexenyl groups, where vinyl and allyl groups are particularly preferred. These alkenyl groups may be directly bonded to both terminals of the perfluoropolyether structure, particularly the divalent perfluorooxyalkylene structure, that constitutes the main chain of the linear perfluoropolyether compound. Alternatively, the alkenyl groups may be bonded through a divalent linking group, which is, for example, —CH₂—, —CH₂O—, —CH₂OCH₂—, or —Y—NR—CO—, wherein Y is —CH₂— or a group represented by the following structural formula (Z) (a dimethylphenylsilylene group in an ortho-, meta-, or para-position):

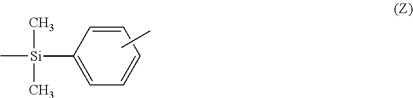

and R is a hydrogen atom, a methyl group, a phenyl group, or an allyl group. Further, the component (A) has at least two alkenyl groups per molecule.

Examples of the component (A) include polyfluorodialkenyl compounds represented by the following general formula (4) or (5):

CH₂═CH—(X)ₚ—Rf²—(X′)ₚ—CH═CH₂ (4)

CH₂═CH—(X)ₚ—Q—Rf²—Q—(X′)ₚ—CH═CH₂ (5)
wherein X independently represents —CH₂—, —CH₂O—, —CH₂OCH₂—, or —Y—NR¹—CO—, wherein Y is —CH₂— or a group represented by the following structural formula (Z), and R¹ is a hydrogen atom, a methyl group, a phenyl group, or an allyl group, and X′ represents —CH₂—, —OCH₂—, —CH₂OCH₂—, or —CO—NR²—Y′—, wherein Y′ is —CH₂— or a group represented by the following structural formula (Z′) and R² is a hydrogen atom, a methyl group, a phenyl group, or an allyl group:

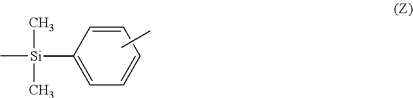

(a dimethylphenylsilylene group in an ortho-, meta-, or para-position)

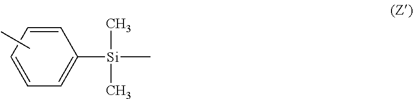

(a dimethylphenylsilylene group in an ortho-, meta-, or para-position)
Rf₂ represents a divalent perfluoropolyether structure (perfluorooxyalkylene structure), which is preferably one represented by the formula (3), namely (CₐF₂ₐO)_{q}, “Q” represents a divalent hydrocarbon group having 1 to 15 carbon atoms and optionally containing an ether bond, specifically, an alkylene group and an alkylene group optionally containing an ether bond, and “p” is independently 0 or 1.

Particularly suitable examples of the linear perfluoropolyether compound (A) include a compound shown by the following general formula (1):

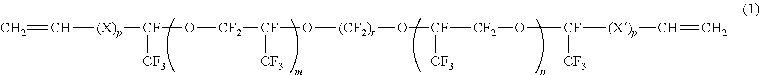

wherein X, X′ and “p” are the same as above, “r” is an integer of 2 to 6, “m” and “n” are each an integer of 0 to 600, and the sum of “m” and “n” is 50 to 600.

The linear perfluoropolyether compound of the general formula (1) desirably has a polyethylene-equivalent weight-average molecular weight of 3,000 to 100,000, particularly desirably 4,000 to 50,000, in molecular weight distribution measurement by gel permeation chromatography (GPC) analysis using a fluorine-based solvent as a developing solvent. The weight-average molecular weight of 3,000 or more ensures reduced swelling of the compound in gasoline and other various types of solvents. In particular, such a molecular weight results in 6% or less swelling in gasoline, allowing the compound to meet the requirements of components that should be gasoline resistant. Meanwhile, the weight-average molecular weight of 100,000 or less is practical because the compound with such a molecular weight is not too viscous and is excellent in workability. The value of the degree of polymerization (m+n) of the linear perfluoropolyether compound of the general formula (1) can be similarly determined as a polyethylene-equivalent number-average polymerization degree or weight-average polymerization degree in molecular weight distribution measurement by gel permeation chromatography (GPC) analysis using a fluorine-based solvent as a developing solvent. The number-average polymerization degree and the number-average molecular weight can also be calculated from the ratio of the terminal structures to the repeating unit structures obtained from a ¹⁹F-NMR spectrum.

Specific examples of the linear perfluoropolyether compound represented by the general formula (1) include those represented by the following formulae.

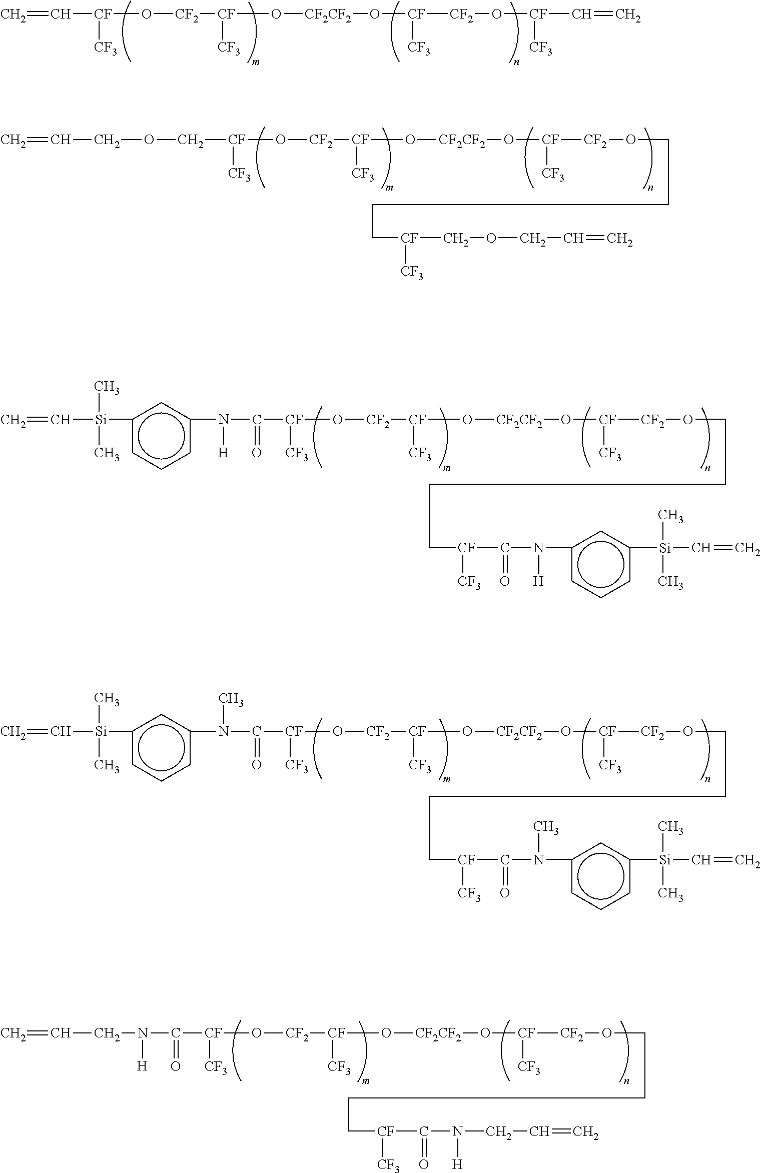

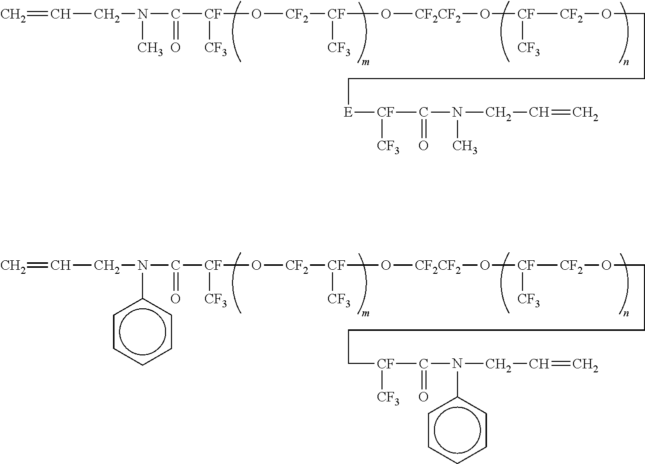

wherein “m” and “n” are each an integer of 0 to 600, preferably 0 to 200, satisfying m+n=50 to 600, preferably m+n=50 to 200.

Further, in accordance with the present invention, to modify the linear perfluoropolyether compound of the formula (1) to a desired weight-average molecular weight for an intended use, the linear perfluoropolyether compound as described above may be preliminarily subjected to hydrosilylation reaction with an organosilicon compound having two SiH groups per molecule using an ordinary method and under ordinary conditions, and the resulting chain-extended product may be used as the component (A). The linear perfluoropolyether compound (A) may be of a single kind or a mixture of two or more kinds.

### Component (B)

In the first aspect of the present invention, the component (B) serves as a crosslinking agent and/or a chain extender for the component (A). The component (B) is a fluorine-containing organohydrogenpolysiloxane having at least two, preferably three or more, silicon atom-bonded hydrogen atoms (hydrosilyl groups represented by SiH) per molecule. Examples of such a component (B) include, but are not limited to, known fluorine-containing organohydrogenpolysiloxanes disclosed in Patent Documents 1, 2, 4.

In that the fluorine-containing organohydrogenpolysiloxane (B) do not contain any such adhesive functional groups having heteroatoms such as nitrogen, oxygen, and sulfur (e.g., alkoxy, epoxy, (meth)acryloxy, and mercapto groups) in the molecule, the fluorine-containing organohydrogenpolysiloxane (B) is clearly distinguished from the optional component (G) described below, namely an organosilicon compound (in particular, organohydrogenpolysiloxane having the adhesive functional groups). Substituted or unsubstituted amide groups, ether bonds (—O—), carbonyl groups (—(C═O)—), and ester groups (—(C═O)O—) are not included in the above adhesive functional groups having heteroatoms.

For the fluorine-containing organohydrogenpolysiloxane (B), fluorine-containing organohydrogenpolysiloxanes that contain, per molecule, one or more of monovalent perfluoroalkyl groups, monovalent perfluorooxyalkyl groups, divalent perfluoroalkylene groups, and/or divalent perfluorooxyalkylene groups can be suitably used, in view of, among others, compatibility with the component (A) or with the component (A) and the component (D) described below in the second aspect of the present invention described below, dispersibility, and uniformity of the cured rubber or gel cured product (adhesive).

Examples of these monovalent or divalent fluorine-containing organic groups include perfluoroalkyl groups, perfluorooxyalkyl groups, perfluoroalkylene groups, and perfluorooxyalkylene groups represented by the following formulae.

C_{g}F_{2g+1}—

—C_{g}F_{2g}

In the formula, g is an integer of 1 to 20, preferably 2 to 10.

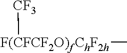

In the formula, f is an integer of 1 to 200, preferably 1 to 100, and h is an integer of 1 to 3.

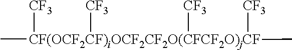

In the formula, “i” and “j” are each an integer of greater than or equal to 1, preferably 1 to 100, and i+j is 2 to 200, preferably 2 to 100, on average.

—(CF₂O)_{d}—(CF₂CF₂O)ₑ—CF₂—

In the formula, “d” and “e” are each an integer of 1 to 50, preferably 1 to 40.

Further, these perfluoroalkyl groups, perfluorooxyalkyl groups, perfluoroalkylene groups, or perfluorooxyalkylene groups are preferably bonded to a silicon atom through a divalent linking group. The divalent linking group may be an alkylene group, an arylene group, or a combination thereof, or any of these groups having an intervening ether-bond oxygen atom, amide bond, carbonyl bond, ester bond, diorganosilylene group, or the like. Example of the linking groups include, but are not limited to, the following divalent linking groups having 2 to 12 carbon atoms.
—CH₂CH₂—,
—CH₂CH₂CH₂—,
—CH₂CH₂CH₂OCH₂—,
—CH₂CH₂CH₂—NH—CO—,
—CH₂CH₂CH₂—N(Ph)—CO—,
—CH₂CH₂CH₂—N(CH₃)—CO—,
—CH₂CH₂CH₂—N(CH₂CH₃)—CO—,
—CH₂CH₂—Si(CH₃)₂—Ph′—N(CH₃)—CO—,
—CH₂CH₂CH₂—Si(CH₃)₂—Ph′—N(CH₃)—CO—,
—CH₂CH₂CH₂—O—CO—

In the formula, Ph represents a phenyl group, and Ph′ represents a phenylene group.

In the fluorine-containing organohydrogenpolysiloxane (B), examples of the silicon atom-bonded monovalent substituent groups other than the above monovalent or divalent fluorine-containing organic groups and silicon atom-bonded hydrogen atoms (SiH groups) include substituted or unsubstituted monovalent hydrocarbon groups having 1 to 20 carbon atoms, preferably 1 to 12 carbon atoms, including: alkyl groups such as methyl, ethyl, propyl, butyl, hexyl, cyclohexyl, octyl, and decyl groups; alkenyl groups such as vinyl and allyl groups; aryl groups such as phenyl, tolyl and naphthyl groups; aralkyl groups such as benzyl and phenylethyl groups; and substituted forms of the foregoing groups in which some or all hydrogen atoms are substituted by chlorine atoms, cyano groups or the like, such as chloromethyl, chloropropyl, and cyanoethyl groups.

The fluorine-containing organohydrogenpolysiloxane (B) may have a siloxane backbone in the molecule that is cyclic, linear, branched, three-dimensional network, or a combination thereof. The number of silicon atoms in the fluorine-containing organohydrogenpolysiloxane is typically, but not limited to, 2 to 60, preferably about 3 to 30.

Examples of the component (B) having such a mono-or divalent fluorine-containing organic group and silicon atom-bonded hydrogen atoms include the following compounds. These compounds may be used alone or in a mixture of two or more thereof. In the following formulae, Me represents a methyl group, and Ph represents a phenyl group.

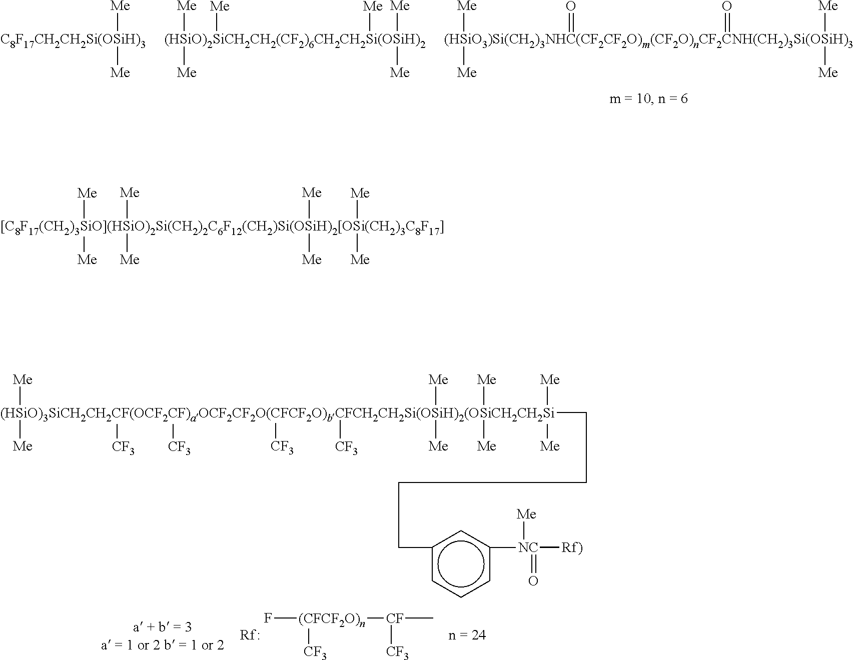

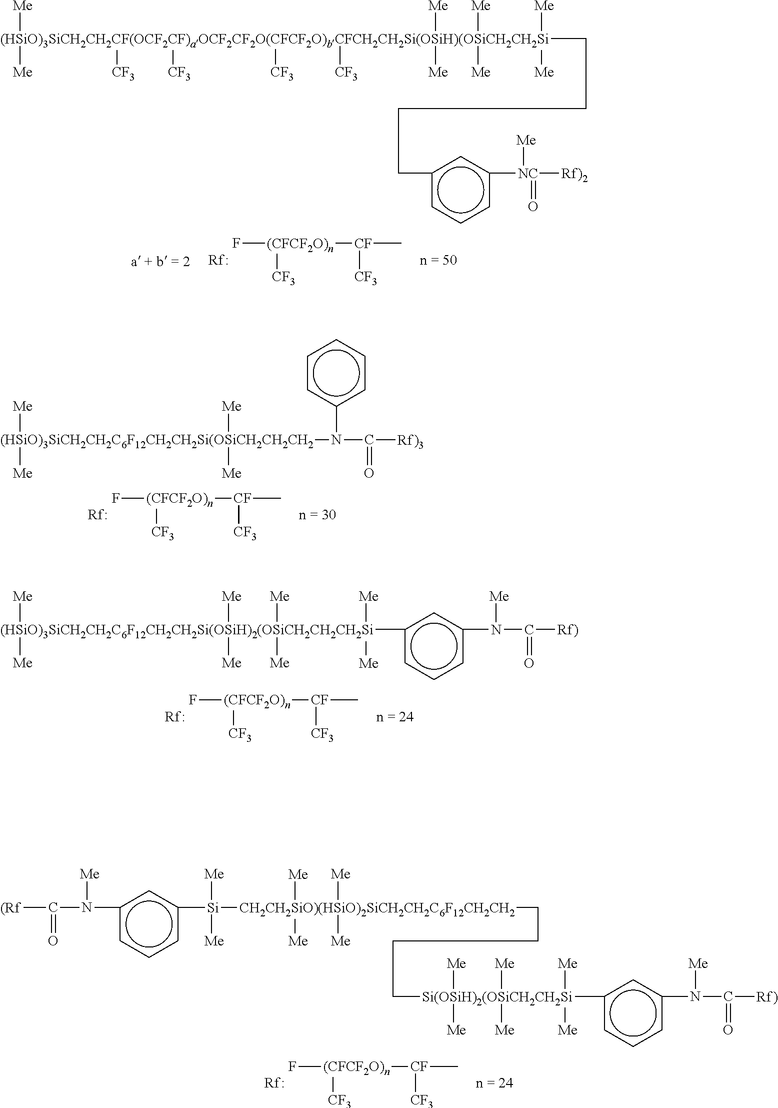

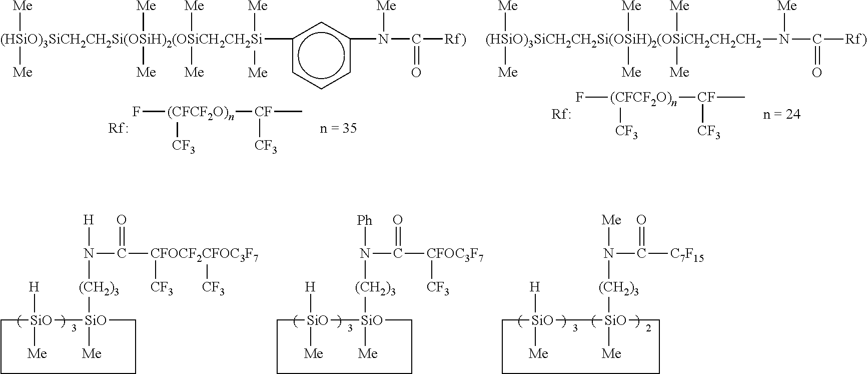

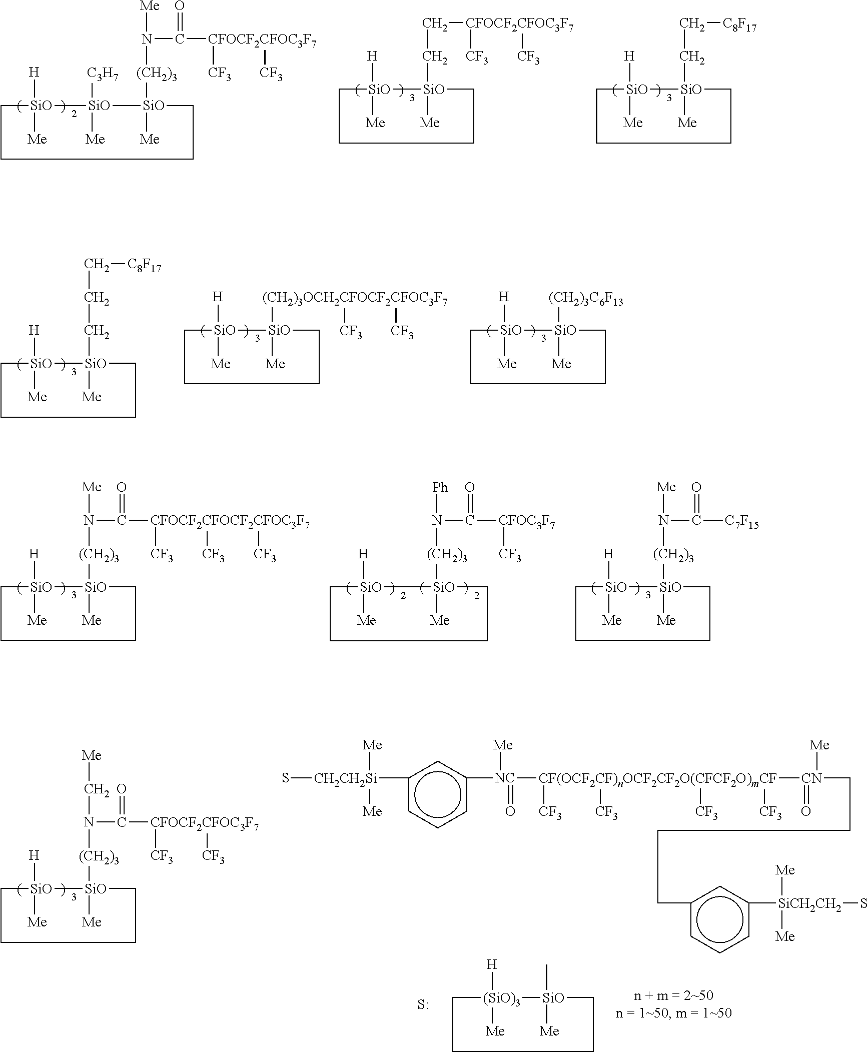

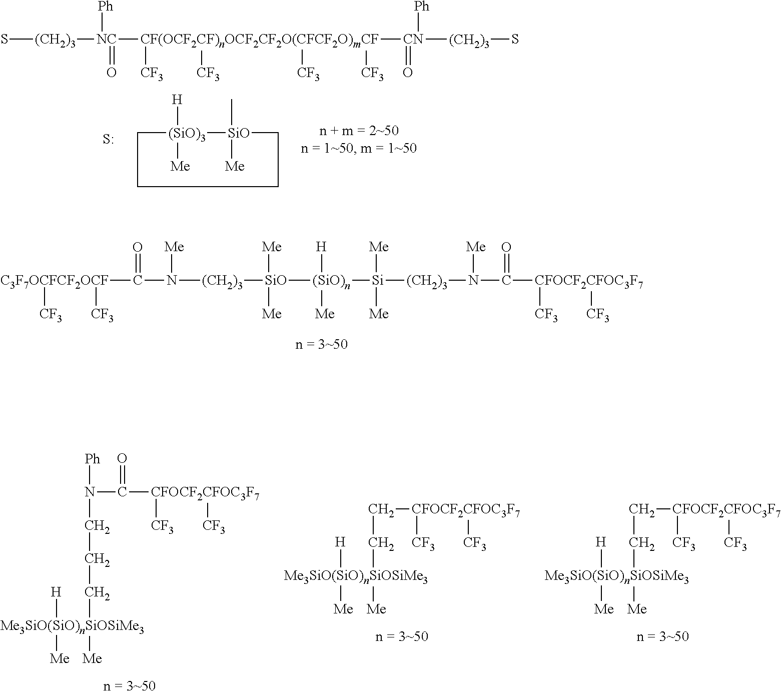

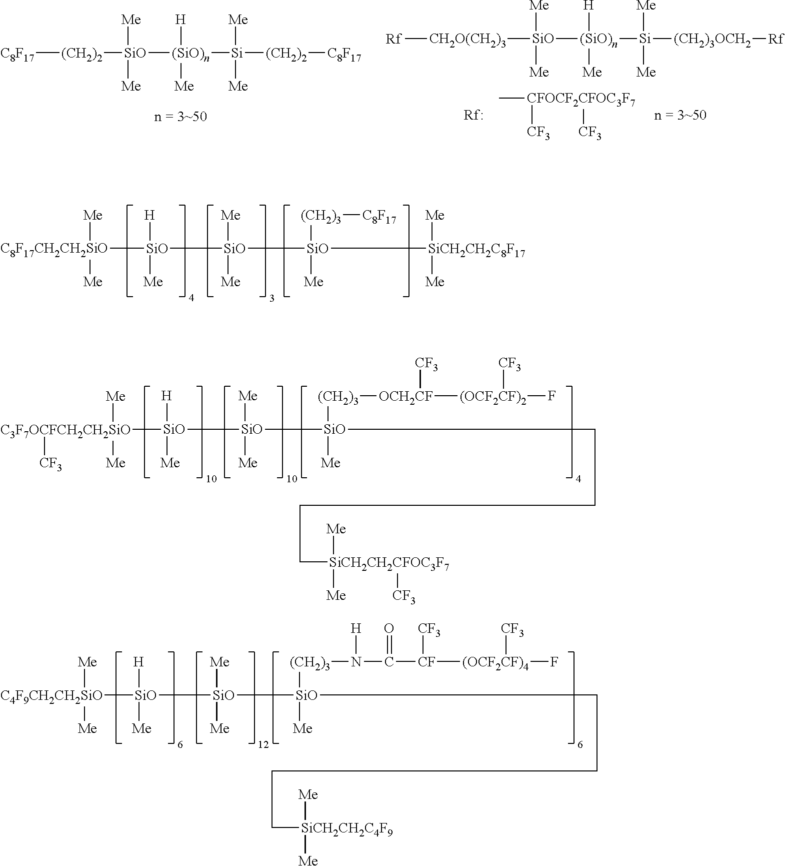

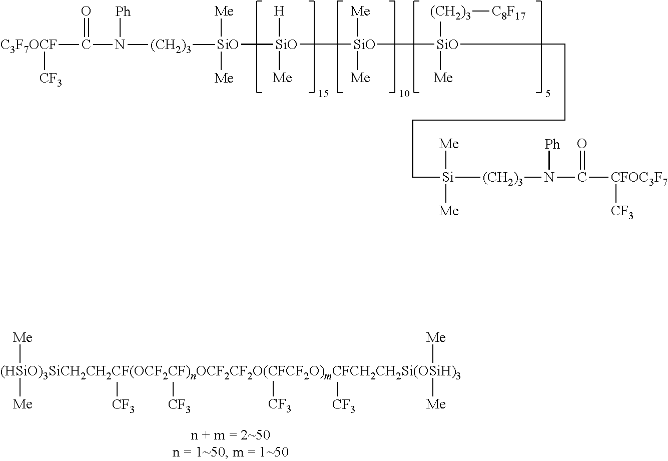

The blended amount of the component (B) is an effective amount for curing the component (A) and the component (D) described below, i.e., an effective curing amount. In particular, the blended amount of the component (B) is such an amount that the hydrosilyl group (Si—H) in the component (B) is preferably 0.2 to 4 mol, more preferably 0.5 to 3 mol relative to 1 mol of the alkenyl group in the component (A) of the composition, or relative to 1 mol of the alkenyl groups in the component (A) and the component (D) in total in the second aspect of the present invention, which is described later. Greater than or equal to 0.2 mol of the hydrosilyl group (Si—H) provides a sufficient degree of crosslinking, ensuring the production of a cured product. Less than or equal to 4 mol of the hydrosilyl group (Si—H) eliminates the risk of foaming during curing.

The component (B) may be of a single kind or a mixture of two or more kinds.

### Component (C)

In the first aspect of the present invention, the hydrosilylation-reaction catalyst (addition-reaction catalyst) (C) of the present invention is a catalyst that promotes an addition reaction between the hydrosilyl groups in the component (B) and the alkenyl groups in the component (A) or the alkenyl groups in the component (A) and the component (D) described below in the second aspect of the present invention described below. Such hydrosilylation-reaction catalysts are generally noble metal (platinum group metal) compounds, which are expensive. As such, platinum or platinum compounds, which are more readily available, are often used.

Examples of the platinum compounds include chloroplatinic acid, complexes of chloroplatinic acid with olefins such as ethylene, complexes of chloroplatinic acid with vinylsiloxanes, and metallic platinum carried on silica, alumina, carbon, or the like. Other known platinum group metal catalysts besides the platinum compounds include rhodium, ruthenium, iridium, and palladium compounds, illustrative examples of which include RhCl(PPh₃)₃, RhCl(CO)(PPh₃)₂, Ru₃(CO)₁₂, IrCl(CO)(PPh₃)₂, and Pd(PPh₃)₄.

The blended amount of the hydrosilylation-reaction catalyst can be a catalytic amount. Generally, the hydrosilylation-reaction catalyst is preferably contained in an amount of 0.1 to 500 ppm (by mass of the platinum group metal), more preferably 0.1 to 100 ppm, relative to the total mass of the components (A), (B), and (D). The hydrosilylation-reaction catalyst (C) may be of a single kind or a mixture of two or more kinds.

The hydrosilylation-reaction catalyst (addition-reaction catalyst) (C) in the present invention does not contain any organic solvent (e.g., the above platinum group metal catalyst is not diluted, dissolved or dispersed in an organic solvent).

### Other Components

In the first aspect (or in the second aspect described below) of the present invention, various additives may be optionally added in addition to the above components (A) to (C).

### Component (E)

In the first aspect (or in the second aspect described below) of the present invention, the inventive composition may optionally contain a regulator for the hydrosilylation-reaction catalyst (addition-reaction regulator) as a component (E) when necessary. Such an addition-reaction regulator does not contain any organic solvent.

The component (E) can be added to prevent the curable perfluoropolyether adhesive composition from thickening or gelling before heat curing, e.g., during preparation of the adhesive composition or application thereof on substrates. Examples of the component (E) include acetylenic alcohols (such as 1-ethynyl-1-hydroxycyclohexane, 3-methyl-1-butyn-3-ol, 3,5-dimethyl-1-hexyn-3-ol, 3-methyl-1-penten-3-ol and phenylbutynol) 3-methyl-3-penten-1-yne, 3,5-dimethyl-3-hexen-1-yne, polymethylvinylsiloxane cyclic compounds, and organophosphorus compounds. The addition of such additives can keep appropriate curing reactivity and shelf stability. The component (E) may be of a single kind or a mixture of two or more kinds.

The blended amount of the component (E) is in the range of 0 to 5 parts by mass relative to 100 parts by mass of the component (A), or relative to 100 parts by mass, in total, of the component (A) and the component (D) described below in the second aspect of the present invention described below, where the blended amount of the component (E) when added is preferably in the range of 0.01 to 5 parts by mass, more preferably in the range of 0.02 to 4 parts by mass. Adding the component (E) in an amount of less than or equal to 5 parts by mass will not decrease the curability of the resulting composition.

### Component (F)

In the first aspect (or in the second aspect described below) of the present invention, the inventive composition may optionally contain a hydrophobic silica powder as a component (F) when necessary. The hydrophobic silica powder (F) is essentially organic solvent-free. The hydrophobic silica powder (F) imparts appropriate physical strength to a cured product obtained from the curable perfluoropolyether adhesive composition and also helps disperse organohydrogen siloxane (G), described below, uniformly in the composition. Suitable hydrophobic silica powder (F) can be obtained through hydrophobization of finely powdered silica having a BET specific surface area of greater than or equal to 50 m²/g, particularly 50 to 400 m²/g, which is a known material as a filler for silicone rubbers.

Examples of the finely powdered silica include a fumed silica (fumed or dry silica), a precipitated silica (wet silica), and a colloidal silica, among which the fumed silica is most preferred.

The silica with the BET specific surface area of greater than or equal to 50 m²/g provides sufficient physical strength of the resulting cured product and allows the component (G) to be uniformly dispersed. The silica with the BET specific surface area of less than or equal to 400 m²/g facilitates kneading operations and allows the component (F) itself to be uniformly dispersed. The BET specific surface area in the present invention can be measured in accordance with DIN 66131.

Examples of hydrophobization agents for the finely powdered silica include organochlorosilane, organodisilazane, cyclic organopolysilazane, and linear organopolysiloxane, among which organochlorosilane, organodisilazane, and cyclic organopolysilazane are preferred.

When the component (F) is added to the inventive composition, the blended amount of the component (F) is preferably 0.5 to 20 parts by mass, more preferably 1 to 18 parts by mass, relative to 100 parts by mass of the component (A), or relative to 100 parts by mass, in total, of the component (A) and the component (D) described below. The blended amount of the component (F) in an amount of greater than or equal to 0.5 parts by mass ensures the effect of adding the component (F). Meanwhile, the blended amount of the component (F) in an amount of less than or equal to 20 parts by mass does not decrease the fluidity of the composition and provides good coatability on substrates.

### Component (G)

Any known tackifier containing epoxy, alkoxy or other groups may be added as a component (G) to impart adhesion.

In the first aspect (or in the second aspect described below) of the present invention, the inventive composition may optionally contain such a tackifier (adhesion aid or adhesion promoter) as the component (G) when necessary.

The tackifier (G) is an optional component that is added when necessary and serves as an aid (adhesion aid or adhesion promoter) to improve the adhesion to substrates. Examples of the component (G) include hydrolyzable organosilane compounds (so-called silane coupling agents or carbon functional silanes) having adhesive functional groups with heteroatoms, such as nitrogen, oxygen, and sulfur (e.g., alkoxy, epoxy, (meth)acryloxy, and mercapto groups) in the molecule and/or their partial hydrolysis condensates. Examples further include organosilicon compounds such as organohydrogen silanes having such adhesive functional groups in the molecule and organohydrogen polysiloxanes having such adhesive functional groups in the molecule. Such organosilicon compounds are preferably those organosilicon compounds (organo(hydrogen)silanes or organo(hydrogen)polysiloxanes) that contain per molecule at least two or more adhesive functional groups of any two or more kinds selected from silicon atom-bonded hydrogen atoms (SiH groups), epoxy groups bonded to silicon atoms via carbon atoms or carbon and oxygen atoms, and trialkoxysilyl groups bonded to silicon atoms via carbon atoms or carbon and oxygen atoms. More preferred organosilicon compounds are organopolysiloxanes having one or more monovalent perfluoroalkyl or monovalent perfluorooxyalkyl groups bonded to silicon atoms via a divalent linking group bonded to silicon atoms and containing carbon atoms or carbon and oxygen atoms, in addition to the above adhesive functional groups of two or more kinds (that is, fluorine-containing organo(hydrogen)polysiloxanes having adhesive functional groups). Among the organosilicon compounds for the component (G), the fluorine-containing organohydrogenpolysiloxane containing an adhesive functional groups differs from the fluorine-containing organohydrogenpolysiloxane (B) described above in that the component (G) has such adhesive functional groups with heteroatoms such as nitrogen, oxygen, and sulfur (e.g., alkoxy, epoxy, (meth)acryloxy, and mercapto groups) in the molecule.

Such an organopolysiloxane has a siloxane backbone that may be cyclic, linear, branched, a mixture thereof, etc.

Specific examples of the component (G) include organosilane compounds containing adhesive functional groups, such as γ-glycidoxypropyltrimethoxysilane, γ-glycidoxypropyltriethoxysilane, β-(3,4-epoxycyclohexyl)ethyltrimethoxysilane, β-(3,4-epoxycyclohexyl)ethyltriethoxysilane, β-(2,3-epoxycyclohexyl)ethyltrimethoxysilane, and β-(2,3-epoxycyclohexyl)ethyltriethoxysilane. Other examples include organopolysiloxanes represented by the following formulae:

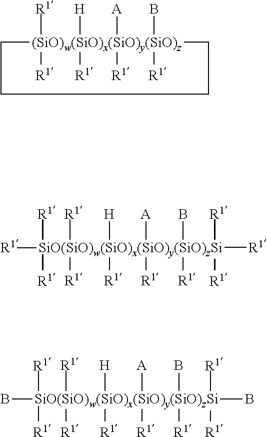

wherein R¹′ is independently an unsubstituted or halogen-substituted monovalent hydrocarbon group, “A” and “B” are as defined below, “w” is an integer of 0≤w≤100, “x” is an integer of 1≤x≤100, “y” is an integer of 1≤y≤100, and “z” is an integer of 0≤z≤100.

The halogen-substituted or unsubstituted monovalent hydrocarbon group of R¹′ preferably contains 1 to 10 carbon atoms, particularly preferably 1 to 8 carbon atoms. Specific examples include: alkyl groups such as methyl, ethyl, propyl, butyl, hexyl, cyclohexyl, and octyl groups; aryl groups such as phenyl and tolyl groups; aralkyl groups such as benzyl and phenylethyl groups; and substituted monovalent hydrocarbon groups obtained by substituting some or all hydrogen atoms of the foregoing groups with halogen atoms such as fluorine. Among these, methyl groups are particularly preferable.

Preferably, “w” is an integer of 0≤w≤20, “x” is an integer of 1≤x≤20, “y” is an integer of 1≤y≤20, and “z” is an integer of 1≤z≤20, where 3≤w+x+y+z≤50 is preferable.

“A” represents an epoxy group bonded to a silicon atom via a carbon atom or via carbon and oxygen atoms, and/or a trialkoxysilyl group bonded to a silicon atom via a carbon atom or via carbon and oxygen atoms. Specific examples include the following groups.

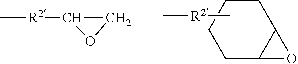

In the formula, R^{2′} represents a divalent hydrocarbon group (such as alkylene and cycloalkylene groups) having 1 to 10 carbon atoms, particularly 1 to 5 carbon atoms, that may optionally contain an intervening oxygen atom.

—R³—Si(OR⁴)₃

In the formula, R³ represents a divalent hydrocarbon group (such as alkylene groups) having 1 to 10 carbon atoms, particularly 1 to 4 carbon atoms, and R⁴ represents a monovalent hydrocarbon group (such as alkyl groups) having 1 to 8 carbon atoms, particularly 1 to 4 carbon atoms.

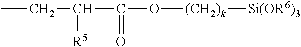

In the formula, R⁵ represents a monovalent hydrocarbon group (such as alkyl groups) having 1 to 8 carbon atoms, particularly 1 to 4 carbon atoms, R⁶ represents a hydrogen atom or a methyl group, and “k” represents an integer of 2 to 10.

“B” represents a monovalent perfluoroalkyl or perfluorooxyalkyl group bonded to a silicon atom via a carbon atom or via carbon and oxygen atoms. Examples of such monovalent perfluoroalkyl or perfluorooxyalkyl groups include those represented by the following general formulae.

C_{g′}F_{2g′+1}—

In the formula, g′ is an integer of 1 to 20, preferably 2 to 10.

F—[CF(CF₃)CF₂O]_{f′}—C_{h′}F_{2h′}—

In the formula, f′ is an integer of 2 to 200, preferably 2 to 100, and h′ is an integer of 1 to 3.

The divalent linking group containing a carbon atom or carbon and oxygen atoms may be an alkylene group, an arylene group, and a combination thereof, or any of these groups with an intervening ether-bond oxygen atom, amide bond, carbonyl bond, or the like. Examples include divalent linking groups having 2 to 12 carbon atoms, such as:
—CH₂CH₂—,
—CH₂CH₂CH₂—,
—CH₂CH₂CH₂OCH₂—,
—CH₂CH₂CH₂—NH—CO—,
—CH₂CH₂CH₂—N(CH₃)—CO—, and
—CH₂CH₂CH₂—N(Ph)—CO—,
wherein Ph is a phenyl group.

These organopolysiloxanes can be prepared by using a conventional method to effect a partial addition reaction on an organohydrogenpolysiloxane having three or more silicon atom-bonded hydrogen atoms (Si—H groups) per molecule with a compound containing an aliphatic unsaturated group, such as vinyl and allyl groups, and an epoxy group and/or a trialkoxysilyl group, and, if necessary, with a compound containing an aliphatic unsaturated group and a perfluoroalkyl or perfluorooxyalkyl group. The number of aliphatic unsaturated groups must be smaller than the number of Si—H groups.

When preparing such organosiloxanes, the target substance may be isolated following the reaction completion. It is also possible to use the resulting mixture from which only unreacted ingredients and the addition-reaction catalyst have been removed.

Specific examples of the organopolysiloxane (G) include those represented by the following structural formulae, wherein Me is a methyl group and Ph is a phenyl group.

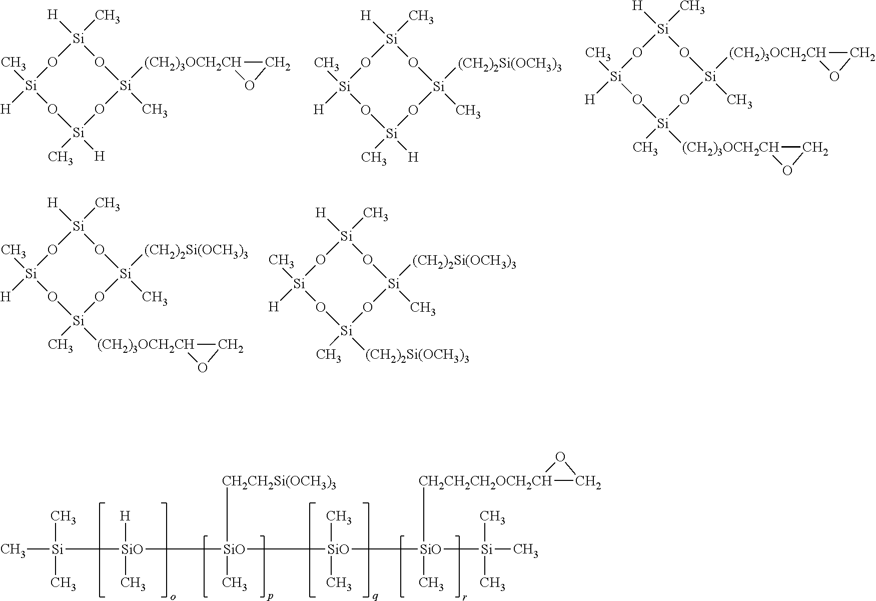

wherein “o,” “q,” and “r” are each a positive integer, and “p” is an integer of greater than or equal to 0.

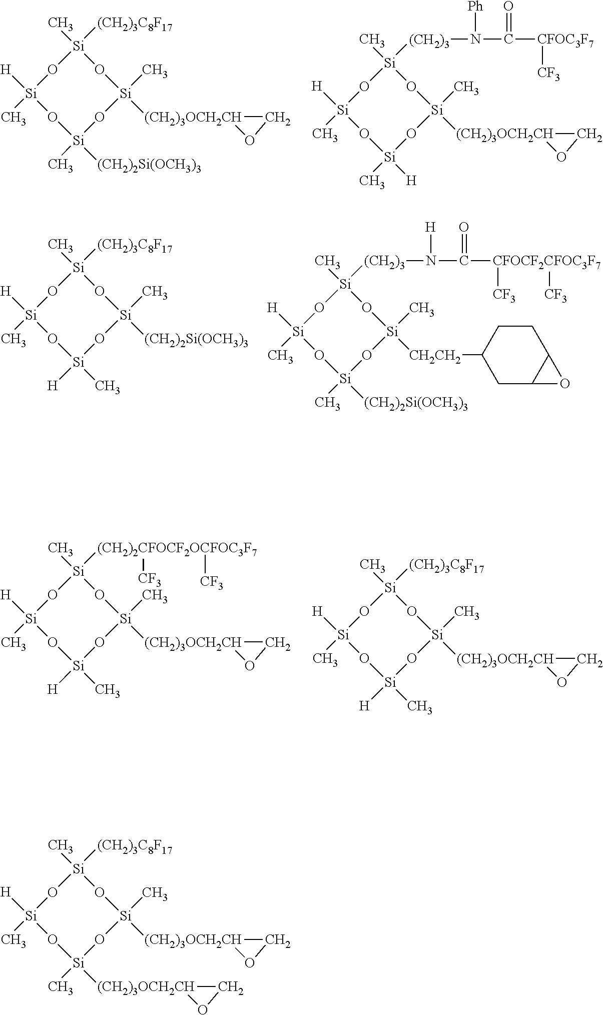

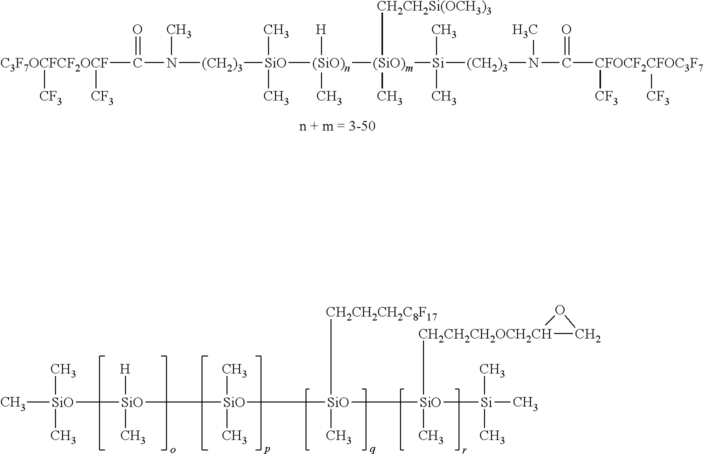

wherein “o,” “q,” and “r” are each a positive integer, and “p” is an integer of greater than or equal to 0.

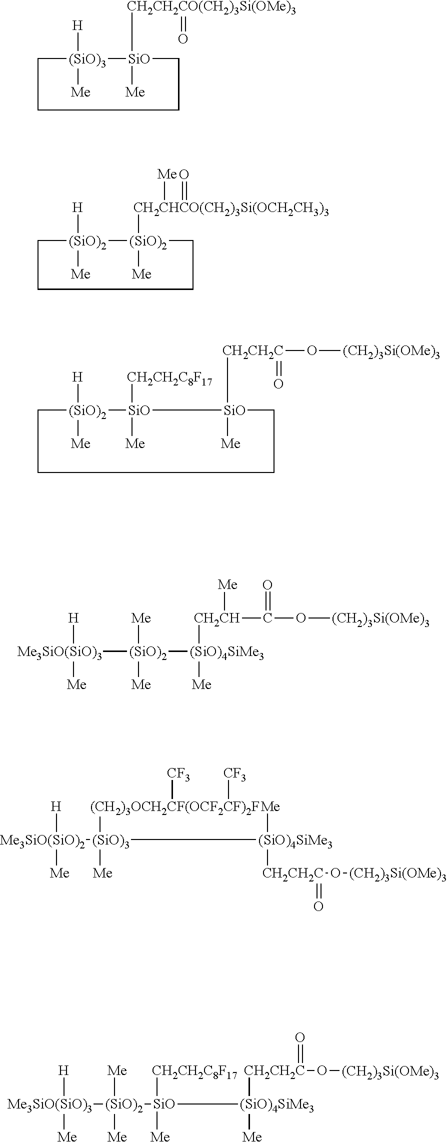

The component (G) may be of a single kind or a mixture of two or more kinds.

The blended amount of the component (G) is 0.05 to 5.0 parts by mass, preferably 0.1 to 3.0 parts by mass, more preferably 0.2 to 1.0 parts by mass, relative to 100 parts by mass of the component (A), or relative to 100 parts by mass, in total, of the component (A) and the component (D) described below in the second aspect of the present invention described below. The blended amount of the component (G) in an amount of greater than or equal to 0.05 parts by mass ensures the effect of adding the component (G). Meanwhile, the blended amount of the component (G) in an amount of less than or equal to 5.0 parts by mass will not impair the fluidity of the composition nor hinder the curability thereof.

### Second Aspect

The second aspect of the present invention is a curable perfluoropolyether adhesive composition that produces a rubber cured product (perfluoropolyether rubber cured product) or a gel cured product (perfluoropolyether gel cured product), comprising:
(A) a linear perfluoropolyether compound having at least two alkenyl groups per molecule and having a perfluoropolyether structure containing a repeating unit represented by —CₐF₂ₐO— in a main chain, wherein “a” represents an integer of 1 to 6: 100 to 40 parts by mass;
(D) a polyfluoromonoalkenyl compound having one alkenyl group per molecule and having a perfluoropolyether structure in a main chain: 0 to 60 parts by mass, wherein the components (A) and (D) are in an amount of 100 parts by mass in total;
(B) a fluorine-containing organohydrogenpolysiloxane having at least two silicon atom-bonded hydrogen atoms per molecule: an effective curing amount; and
(C) a hydrosilylation-reaction catalyst: a catalytic amount,
wherein the curable perfluoropolyether adhesive composition does not contain any organic solvent in the composition.

In the second aspect of the present invention, the components (A) to (C) can be the same as those described above.

### Component (D)

The component (D) is used in the particular second aspect of the inventive curable perfluoropolyether adhesive composition (i.e., a composition that produces a gel cured product), as compared to the aforementioned first aspect of the present invention (i.e., a composition that produces a rubber cured product). The component (D) is a polyfluoromonoalkenyl compound having one alkenyl group per molecule and having a perfluoropolyether structure in a main chain. Particularly preferred is a polyfluoromonoalkenyl compound represented by the following general formula (2).

Rf²—(X′)ₚ—CH═CH₂ (2)

In the formula, X′ and “p” are the same as defined in the general formula (1), and Rf¹ is a perfluoropolyether structure (monovalent perfluoropolyether group) represented by the following general formula:

F—[CF(CF₃)CF₂O]_{w}—CF(CF₃)—
wherein “w” represents an integer of 1 to 500, preferably 2 to 200.

Specific examples of the polyfluoromonoalkenyl compound represented by the general formula (2) include the following.

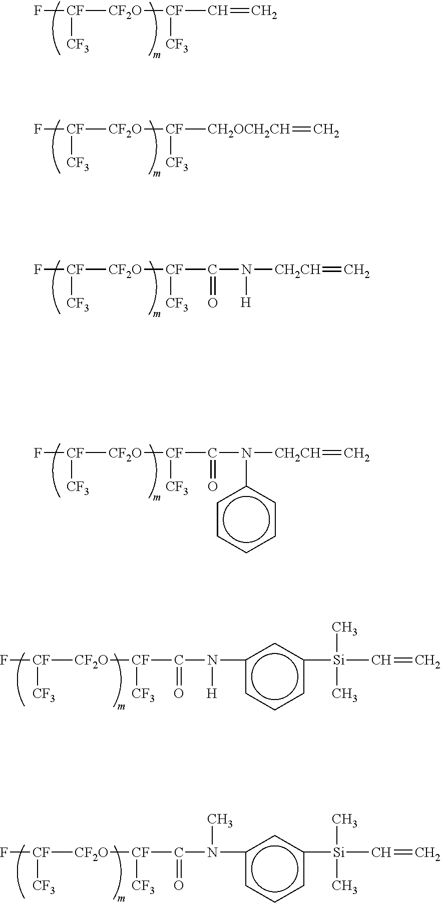

In the formula, “m” is an integer of 1 to 200, in particular 2 to 100.

When the polyfluoromonoalkenyl compound (D) is added, the blended amount thereof is selected so that, in the curable perfluoropolyether adhesive composition, the linear perfluoropolyether dialkenyl compound (A) and the component (D) satisfy the ratio of the component (A): 100 to 40 parts by mass and the component (D): 0 to 60 parts by mass, wherein the total of the component (A) and the component (D) is 100 parts by mass.

For example, the perfluoropolyether adhesive composition in the second aspect of the present invention can contain the component (D) in an amount of 0.1 to 60 parts by mass, preferably 1 to 60 parts by mass, particularly preferably 5 to 50 parts by mass, further preferably 8 to 40 parts by mass, relative to 99.9 to 40 parts by mass, preferably 99 to 40 parts by mass, particularly preferably 95 to 50 parts by mass, further preferably 92 to 60 parts by mass of the component (A), such that the components (A) and (D) are in an amount of 100 parts by mass in total. The polyfluoromonoalkenyl compound (D) may be of a single kind or a mixture of two or more kinds.

### Other Components

In the second aspect of the present invention, various additives may be optionally added in addition to the above components (A) to (D), as with the first aspect. The regulator (E) for the hydrosilylation-reaction catalyst, the hydrophobic silica powder (F), and the organosilicon compound containing adhesive functional groups (G) can be the same as those illustrated above.

### Cured Product

The inventive perfluoropolyether adhesive composition, when cured, forms an adhesive consisting of a perfluoropolyether rubber or gel cured product having a surface adhesion of, for example, 0.001 to 10.0 N/25 mm, preferably 0.002 to 8.0 N/25 mm, more preferably 0.003 to 6.0 N/25 mm. The inventive composition can form a cured product (adhesive) with excellent heat resistance, water repellency, oil repellency, weather resistance, chemical resistance, solvent resistance, etc. and with good adhesiveness to resins and metal substrates. As such, the inventive composition can be used in various applications.

For example, in the first aspect of the present invention, a cured product can be formed by curing the perfluoropolyether adhesive composition, where the composition contains, relative to 100 parts by mass of the component (A), the component (B) in such an amount that 0.2 to 3.0 mol of the hydrosilyl groups in the component (B) is contained per mol of the total alkenyl groups in the component (A), as well as the component (C) in an amount of 0.1 to 100 ppm in platinum equivalent relative to the total amount of the components (A) and (B).

Also, for example, in the second aspect of the present invention, a cured product can be formed by curing the perfluoropolyether adhesive composition, where the composition contains, relative to 40 to 80 parts by mass of the component (A), the component (D) in an amount of 20 to 60 parts by mass, the components (A) and (D) being in an amount of 100 parts by mass in total, and the component (B) in such an amount that 0.2 to 3.0 mol of the hydrosilyl groups in the component (B) is contained per mol of the total alkenyl groups in the components (A) and (D), as well as the component (C) in an amount of 0.1 to 100 ppm in platinum equivalent relative to the total amount of the components (A), (B), and (D).

The cured product of the perfluoropolyether adhesive composition described above is formed by any conventional method, such as coating an appropriate substrate with any one of the inventive compositions followed by curing of the composition, or bonding. Curing can be easily performed by heat treatment at a temperature of typically 60 to 150° C. for about 1 to 60 minutes.

The adhesive based on the cured product of the inventive perfluoropolyether adhesive composition can be used, for example, for automobiles, chemical plants, semiconductor manufacturing lines, analytical and scientific instruments, medical equipment, aircrafts, and optical components.

Further, the adhesive tape, which is for example obtained by laminating the cured product (perfluoropolyether rubber cured product or perfluoropolyether gel cured product) layer of the inventive curable perfluoropolyether adhesive composition on a substrate made of an organic resin film, such as polyethylene terephthalate (PET) film, has excellent heat resistance, oil resistance, low-temperature properties, moisture resistance, low gas permeability, etc. and is particularly useful as an adhesive tape having a non-conductive adhesive layer with excellent chemical and solvent resistance.

When coating is performed with the inventive adhesive composition, it is advantageous to use a known primer in combination to improve the bond or adhesion to the substrate. The use of a primer prevents penetration of chemicals and solvents through the substrate interface, and improves acid resistance, chemical resistance, and solvent resistance of the entire components.

Possible primers may include silane primers based on silane coupling agents, organohydrogenpolysiloxane-based primers, synthetic rubber-based primers, acrylic resin-based primers, urethane resin-based primers, and epoxy resin-based primers. Possible primers may further include a composition in which the inventive perfluoropolyether rubber composition is added with a tackifier added thereto.

The cured product (perfluoropolyether rubber cured product or perfluoropolyether gel cured product) of the inventive curable perfluoropolyether adhesive composition is preferably a non-conductive adhesive having a volume resistivity of 1×10⁹ Ω·cm or more. Such an inventive curable perfluoropolyether adhesive composition is suitable as a material for non-conductive adhesives. For example, the upper limit of the volume resistivity of the cured product of the inventive curable perfluoropolyether adhesive composition can be, but not limited to, 1×10¹³ Ω·cm.

Such an inventive perfluoropolyether adhesive composition can produce a cured product (adhesive) that has excellent heat resistance, weather resistance, oil resistance, low-temperature properties, moisture resistance, low gas permeability, water repellency, oil repellency, etc., and in particular provides a smooth coating film without any organic solvent-derived voids on the film surface after application on the substrate.

The third aspect of the present invention is an adhesive including the cured product (perfluoropolyether rubber cured product or perfluoropolyether gel cured product) of the inventive curable perfluoropolyether adhesive composition as previously described.

As previously described, the inventive perfluoropolyether adhesive composition produces a cured product (adhesive) that has excellent heat resistance, weather resistance, oil resistance, chemical resistance, solvent resistance, low-temperature properties, moisture resistance, low gas permeability, water repellency, oil repellency, etc., and in particular provides a smooth coating film free from voids on the cured film surface. As such, the inventive adhesive has excellent heat resistance, weather resistance, oil resistance, chemical resistance, solvent resistance, low-temperature properties, moisture resistance, low gas permeability, water repellency, oil repellency, etc., and provides a smooth coating film free from voids on the cured film surface.

Further, the fourth aspect of the present invention is an adhesive tape including a laminated cured product layer of the inventive curable perfluoropolyether adhesive composition as previously described.

As previously described, the inventive perfluoropolyether adhesive composition produces a cured product (adhesive) that has excellent heat resistance, weather resistance, oil resistance, chemical resistance, solvent resistance, low-temperature properties, moisture resistance, low gas permeability, water repellency, oil repellency, etc., and in particular provides a smooth coating film free from voids on the cured film surface. As such, the inventive adhesive tape has excellent heat resistance, weather resistance, oil resistance, chemical resistance, solvent resistance, low-temperature properties, moisture resistance, low gas permeability, water repellency, oil repellency, etc., and provides a smooth coating film free from voids on the cured film surface.

To enhance the effect of surface modification, the substrate surface may be degreased with an organic solvent or the like or prebaked prior to plasma irradiation.

### EXAMPLE

The present invention will now be further detailed with reference to Examples and Comparative Examples, though the present invention is not limited to Examples given below. In the following examples, “%” indicates “mass %”.

### Examples 1 to 5, Comparative Examples 1 to 5

Using the following ingredients, the curable perfluoropolyether adhesive compositions shown in Table 1 were prepared. These adhesive compositions were cured at 130° C. for 5 minutes. The resulting cured products were measured for a surface adhesion, and also subjected to a solvent resistance test, a pencil hardness test, an adhesiveness test, and a coating film surface observation that were performed according to the methods described below. The results are collectively shown in Table 1.

### INGREDIENTS

### (A) Linear Perfluoropolyether Compound

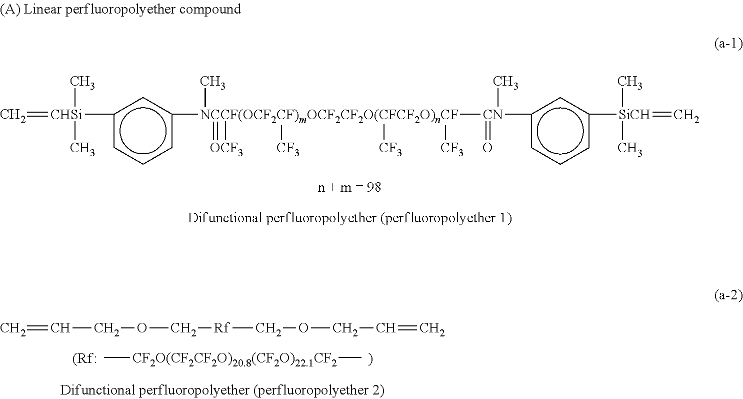 [0197] wherein the repeating units CF₂CF₂O and CF₂O are randomly arranged.

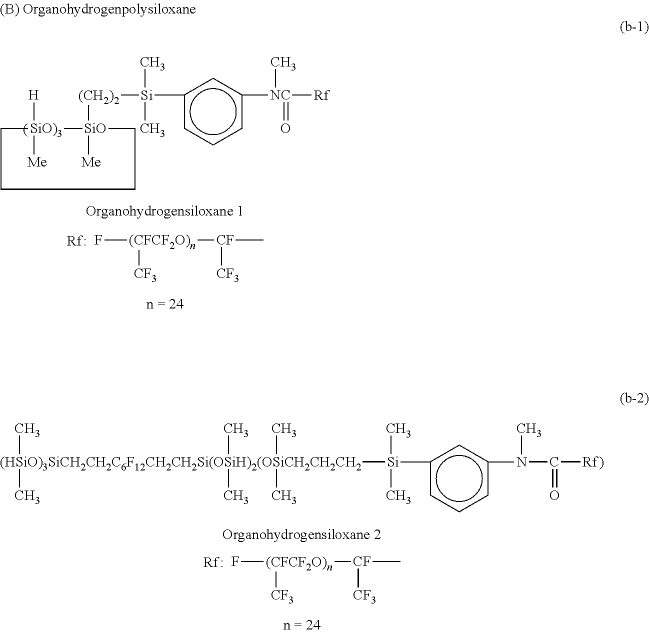

### (C) Addition-Reaction Catalyst (Platinum Compound)

(c-1) CAT-PL-56 (Available Under this Tradename from Shin-Etsu Chemical Co., Ltd., an Organic Solvent-Free Product)
(c-2) CAT-PL-50T (Available Under this Tradename from Shin-Etsu Chemical Co., Ltd., a Toluene-Containing Product)

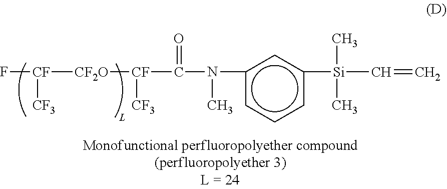

### (E) Curing Regulator

(e-1) Ethynylcyclohexanol
(e-2) Ethynylcyclohexanol/50% Toluene Solution

### (F) Hydrophobic Silica Powder (Added as a Base Compound F Described Below)

### Preparation of Base Compound F

A planetary mixer was charged with 100 parts of a polymer of the above formula (a-1). While the mixer was kept at an internal temperature of 50 to 100° C., 10 parts of dimethyldichlorosilane-surface treated fumed silica (BET specific surface area: 110 m²/g) were added in divided portions. The heating was then stopped, followed by kneading under a reduced pressure (gauge pressure: −0.093 MPa) for one hour. With kneading continued, the mixer was heated until the internal temperature reached 130° C. With the internal temperature kept at 130 to 160° C., the mixture was heat-treated for one hour under a reduced pressure (gauge pressure: −0.093 MPa). Following cooling to 40° C. or below, the mixture was taken out and subjected to two passes on a three-roll mill, resulting a base compound F (base F).

### (G) Organosilicon Compound Containing Adhesive Functional Groups

### (Adhesiveness-Imparting Siloxane Compound (Siloxane Compound 1))

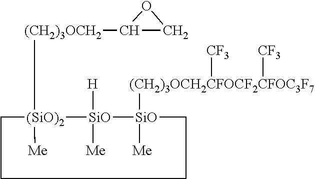

### Adhesion Measurement

Each of the compositions of Examples and Comparative Examples was applied on a 50-μm thick, 25-mm wide PET (polyethylene terephthalate) film using an applicator such that the composition was 30 μm thick. Each composition was then heated at 130° C. for 5 minutes to cure into a rubber or gel form. Thus, adhesive tapes in which the 30-μm thick adhesive layer (rubber or gel cured product layer) is laminated on the 50-μm thick PET film were produced. Each of these adhesive tapes was bonded to a metal plate (polished stainless steel plate), and the adhesive tapes were pressure-bonded by reciprocating one time a 2 Kg roller covered with a rubber layer on the tape substrate. Following standing for 20 hours at room temperature, a tensile tester was used at 25° C. to measure the force (N/25 mm) required to peel the adhesive tape away from the stainless steel plate at a tensile rate of 300 mm/minute and at an angle of 180°, as the adhesion of each adhesive layer (rubber or gel cured product layer).

### Solvent Resistance Test (Weight Change)

A 32 ϕ×15 mm glass container was charged with 3 g of the respective compositions of Examples and Comparative Examples. Each of the compositions was then cured at 130° C. for 5 minutes to produce a sample. Each sample was immersed in xylene and Fuel C (a 50/50 (wt %) mixed solution of toluene/isooctane) at 25° C. for 7 days. The weight change rate before and after the immersion was measured.

### Pencil Hardness (Scratch Resistance) Test

In accordance with JIS K5600-5-4, the scratch resistance was determined based on the pencil lead hardness that made a crack by scratching at 45° with a pencil lead.

### Adhesiveness Test

Each of the compositions of Examples and Comparative Examples was applied on an adherend made of epoxy glass such that the composition was 100 μm thick. Each composition was then heated at 130° C. for 5 minutes to cure into a rubber or gel form, resulting in a substrate with an adhesive layer laminated thereon. The adhesive layer on each substrate was rubbed with a finger ten times. The adhesive layers that did not peel away from the substrate was evaluated as “good,” while those that peeled away from the substrate to expose the substrate surface was evaluated as “poor.”

### Coating Film Surface Condition Observation

The substrate was prepared in the same manner as in the above adhesiveness test, and each adhesive layer on the substrate was observed under an optical microscope. The adhesive layers that had no observable voids were evaluated as “good,” while those that had observable voids were evaluated as “poor.”

TABLE 1

| Component | | Examples | | | | | Comparative Examples | | | | |
|---|---|---|---|---|---|---|---|---|---|---|---|
| (parts by mass) | | 1 | 2 | 3 | 4 | 5 | 1 | 2 | 3 | 4 | 5 |
| a-1 | Perfluoro- | 76.5 | 90.5 | 100 | 70 | | 90.5 | 90.5 | 90.5 | 90.5 | 100 |
| | polyether | | | | | | | | | | |
| | 1 | | | | | | | | | | |
| a-2 | Perfluoro- | | | | | 100 | | | | | |
| | polyether | | | | | | | | | | |
| | 2 | | | | | | | | | | |
| D | Perfluoro- | 23.5 | 9.5 | | | | 9.5 | 9.5 | 9.5 | 9.5 | |
| | polyether | | | | | | | | | | |
| | 3 | | | | | | | | | | |
| F | Base F | | | | 33 | | | | | | |
| b-1 | Organo- | 25.5 | 22.9 | | | | | 22.9 | 22.9 | 22.9 | |
| | hydrogen- | | | | | | | | | | |
| | siloxane 1 | | | | | | | | | | |
| b-2 | Organo- | | | 18.1 | 18.1 | 74.7 | | | | | 18.1 |
| | hydrogen- | | | | | | | | | | |
| | siloxane 2 | | | | | | | | | | |
| G | Siloxane | 0.2 | 0.2 | 0.2 | 0.2 | 0.2 | 0.2 | 0.2 | 0.2 | 0.2 | 0.2 |
| | compound | | | | | | | | | | |
| c-1 | Platinum | 0.25 | 0.24 | 0.24 | 0.24 | 0.35 | 0.24 | | | 0.24 | |
| | compound | | | | | | | | | | |
| c-2 | Platinum | | | | | | | | 0.24 | | 0.24 |
| | compound | | | | | | | | | | |
| e-1 | Curing | 0.02 | 0.02 | 0.02 | 0.02 | 0.03 | 0.02 | 0.02 | 0.02 | | |
| | regulator | | | | | | | | | | |
| e-2 | Curing | | | | | | | | | 0.04 | 0.04 |
| | regulator | | | | | | | | | | |

| | | | | | | | | | | |
|---|---|---|---|---|---|---|---|---|---|---|
| Adhesion | 2.3 | 0.68 | 0.07 | 0.05 | 0.05 | Not | Not | 0.66 | 0.70 | 0.06 |
| (N/25 mm) | | | | | | cured | cured | | | |
| Solvent | 3.1 | 2.0 | 1.5 | 1.2 | 1.3 | | | 2.4 | 1.8 | 1.2 |
| resistance (%) | | | | | | | | | | |
| Xylene | | | | | | | | | | |
| Solvent | 2.5 | 1.7 | 1.0 | 0.8 | 1.1 | | | 1.3 | 1.5 | 0.9 |
| resistance (%) | | | | | | | | | | |
| Fuel C | | | | | | | | | | |
| Adhesiveness | Good | Good | Good | Good | Good | | | Good | Good | Good |
| Pencil hardness | 6B | 6B | 5B | 4B | 5B | | | 6B | 6B | 5B |
| test | | | | | | | | | | |
| Voids on | Good | Good | Good | Good | Good | | | Poor | Poor | Poor |
| film surface | | | | | | | | | | |
| Organic solvent | 0 | 0 | 0 | 0 | 0 | | | 0.10 | 0.02 | 0.12 |
| content (%) | | | | | | | | | | |

As shown in Table 1, the adhesives of Examples 1 to 5, which used the inventive curable perfluoropolyether adhesive composition, had good adhesiveness to the substrate and also had no voids on the cured film surface. In contrast, the compositions of Comparative Examples 1 and 2, which did not contain the essential component (B) or (C) of the present invention, were not successfully cured. Also, the compositions of Comparative Examples 3 to 5, which contained an organic solvent in the composition due to their component (C) or (E) containing the organic solvent, had observable voids on the cured film surface.

From the above, it was found that the present invention can provide a curable perfluoropolyether adhesive composition that has excellent heat resistance, weather resistance, water repellency, oil repellency, chemical resistance, and solvent resistance and is particularly free from voids that may otherwise occur on the coating film surface during heating processes.

It should be noted that the present invention is not limited to the above-described embodiments. The embodiments are just examples, and any examples that substantially have the same feature and demonstrate the same functions and effects as those in the technical concept disclosed in claims of the present invention are included in the technical scope of the present invention.

1-14. (canceled)

15. A curable perfluoropolyether adhesive composition comprising:
(A) a linear perfluoropolyether compound having at least two alkenyl groups per molecule and having a perfluoropolyether structure containing a repeating unit represented by —CₐF₂ₐO— in a main chain, wherein “a” represents an integer of 1 to 6: 100 parts by mass;
(B) a fluorine-containing organohydrogenpolysiloxane having at least two silicon atom-bonded hydrogen atoms per molecule: an effective curing amount; and
(C) a hydrosilylation-reaction catalyst: a catalytic amount,
wherein the curable perfluoropolyether adhesive composition does not contain any organic solvent in the composition.

16. The curable perfluoropolyether adhesive composition according to claim 15, further comprising (E) an organic solvent-free addition reaction regulator in an amount of 0.01 to 5 parts by mass relative to 100 parts by mass of the component (A).

17. The curable perfluoropolyether adhesive composition according to claim 15, further comprising (F) a hydrophobic silica powder in an amount of 0.5 to 20 parts by mass relative to 100 parts by mass of the component (A).

18. A curable perfluoropolyether adhesive composition comprising:
(A) a linear perfluoropolyether compound having at least two alkenyl groups per molecule and having a perfluoropolyether structure containing a repeating unit represented by —CₐF₂ₐO— in a main chain, wherein “a” represents an integer of 1 to 6: 100 to 40 parts by mass;
(D) a polyfluoromonoalkenyl compound having one alkenyl group per molecule and having a perfluoropolyether structure in a main chain: 0 to 60 parts by mass, wherein the components (A) and (D) are in an amount of 100 parts by mass in total;
(B) a fluorine-containing organohydrogenpolysiloxane having at least two silicon atom-bonded hydrogen atoms per molecule: an effective curing amount; and
(C) a hydrosilylation-reaction catalyst: a catalytic amount,
wherein the curable perfluoropolyether adhesive composition does not contain any organic solvent in the composition.

19. The curable perfluoropolyether adhesive composition according to claim 18, wherein the curable perfluoropolyether adhesive composition contains the component (D) in an amount of 0.1 to 60 parts by mass relative to 99.9 to 40 parts by mass of the component (A), wherein the components (A) and (D) are in an amount of 100 parts by mass in total.

20. The curable perfluoropolyether adhesive composition according to claim 18, wherein the component (D) is a polyfluoromonoalkenyl compound represented by the following general formula (2):
Rf¹—(X′)ₚ—CH═CH₂ (2)
wherein X′ represents —CH₂—, —OCH₂—, —CH₂OCH₂—, or —CO—NR²—Y′—, wherein Y′ represents —CH₂— or a group represented by the following structural formula (Z′): 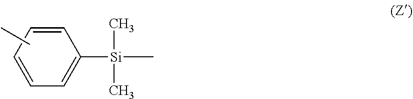
and R² represents a hydrogen atom, a methyl group, a phenyl group, or an allyl group,
wherein “p” represents 0 or 1, and Rf¹ represents a perfluoropolyether structure represented by a general formula: F—[CF(CF₃)CF₂O]_{w}—CF(CF₃)—, wherein “w” represents an integer of 1 to 500.

21. The curable perfluoropolyether adhesive composition according to claim 18, further comprising (E) an organic solvent-free addition reaction regulator in an amount of 0.01 to 5 parts by mass relative to 100 parts by mass of the components (A) and (D) in total.

22. The curable perfluoropolyether adhesive composition according to claim 18, further comprising (F) a hydrophobic silica powder in an amount of 0.5 to 20 parts by mass relative to 100 parts by mass of the components (A) and (D) in total.

23. The curable perfluoropolyether adhesive composition according to claim 15, wherein the component (C) does not contain any organic solvent.

24. The curable perfluoropolyether adhesive composition according to claim 18, wherein the component (C) does not contain any organic solvent.

25. The curable perfluoropolyether adhesive composition according to claim 15, wherein the component (A) is a linear perfluoropolyether compound represented by the following general formula (1): 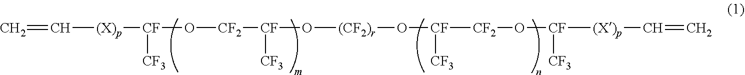
wherein X represents —CH₂—, —CH₂O—, —CH₂OCH₂—, or —Y—NR¹—CO—, wherein Y represents —CH₂— or a group represented by the following structural formula (Z), and R¹ represents a hydrogen atom, a methyl group, a phenyl group, or an allyl group,
wherein X′ represents —CH₂—, —OCH₂—, —CH₂OCH₂—, or —CO—NR²—Y′—, wherein Y′ represents —CH₂— or a group represented by the following structural formula (Z′), and R² represents a hydrogen atom, a methyl group, a phenyl group, or an allyl group,
wherein “p” independently represents 0 or 1, “r” represents an integer of 2 to 6, “m” and “n” each represent an integer of 0 to 600, and a sum of “m” and “n” is 50 to 600.

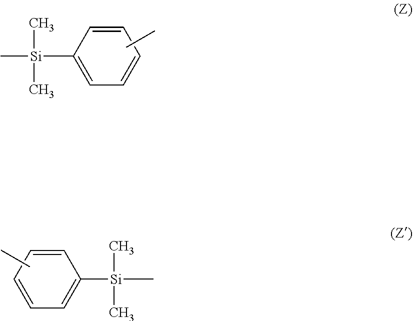

26. The curable perfluoropolyether adhesive composition according to claim 18, wherein the component (A) is a linear perfluoropolyether compound represented by the following general formula (1): 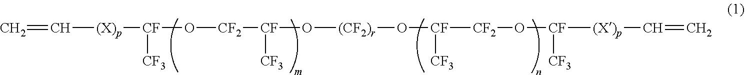
wherein X represents —CH₂—, —CH₂O—, —CH₂OCH₂—, or —Y—NR¹—CO—, wherein Y represents —CH₂— or a group represented by the following structural formula (Z), and R¹ represents a hydrogen atom, a methyl group, a phenyl group, or an allyl group,
wherein X′ represents —CH₂—, —OCH₂O—, —CH₂OCH₂—, or —CO—NR²—Y—, wherein Y represents —CH₂— or a group represented by the following structural formula (Z′), and R² represents a hydrogen atom, a methyl group, a phenyl group, or an allyl group,
wherein “p” independently represents 0 or 1, “r” represents an integer of 2 to 6, “m” and “n” each represent an integer of 0 to 600, and a sum of “m” and “n” is 50 to 600.

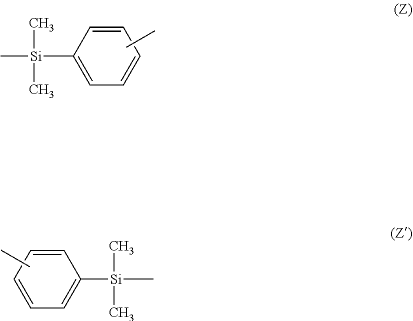

27. The curable perfluoropolyether adhesive composition according to claim 15, wherein the curable perfluoropolyether adhesive composition, when cured, forms an adhesive having an adhesion of 0.001 N/25 mm to 10.0 N/25 mm.

28. The curable perfluoropolyether adhesive composition according to claim 18, wherein the curable perfluoropolyether adhesive composition, when cured, forms an adhesive having an adhesion of 0.001 N/25 mm to 10.0 N/25 mm.

29. The curable perfluoropolyether adhesive composition according to claim 15, wherein a cured product of the curable perfluoropolyether adhesive composition is a non-conductive adhesive having a volume resistivity of 1×10⁹ Ω·cm or more.

30. The curable perfluoropolyether adhesive composition according to claim 18, wherein a cured product of the curable perfluoropolyether adhesive composition is a non-conductive adhesive having a volume resistivity of 1×10⁹ Ω·cm or more.

31. An adhesive comprising a cured product of the curable perfluoropolyether adhesive composition according to claim 15.

32. An adhesive comprising a cured product of the curable perfluoropolyether adhesive composition according to claim 18.

33. An adhesive tape comprising a substrate and a cured product layer of the curable perfluoropolyether adhesive composition according to claim 15 laminated thereon.

34. An adhesive tape comprising a substrate and a cured product layer of the curable perfluoropolyether adhesive composition according to claim 18 laminated thereon.
